(19) United States
(12) Patent Application Publication
(10) Pub. No.: US 2003/0020616 A1
(43) Pub. Date: Jan. 30, 2003

(54) Light curtain repeater system and method of operation

(76) Inventor: Matthew Kevin Dodds, Oshawa (CA)

Correspondence Address: Matt Dodds, 1442 Bridgeport Street, Oshawa, ON, LIK 2P5, CA

(21) Appl. No.: 09/915,330

(22) Filed: Jul. 27, 2001

(51) Int. Cl. G08B 13/18

(52) U.S. Cl. 340/600; 250/221

(57) ABSTRACT

A light curtain repeater system and method of operation would include a light receiving array and a light emitting array, and may also contain an optional received light intensity indicator and/or a method to extend the separation of the receiving and emitting arrays.

### CROSS-REFERENCE

U.S. Pat. No. 5,302,942 April, 1994 Blau

### BACKGROUND OF THE INVENTION

1. Field of the Invention

Described in this invention is a device(s), which is utilized with existing or new installations of light curtains. This may include, but, is not limited to the following; safety light curtains, area sensors, security arrays or any other single or multiple light beam device consisting of a separate emitter and receiver assembly for the purpose of detecting a person or an object. An example of one type of system, is a “safety light curtain”, these are used as a means of guarding hazardous industrial equipment by detecting the presence of a human or part of a human body and issuing a stop command to halt the operation of the machine.

2. Description of Related Art

The following descriptions deal mainly with, but are not limited to, safety light curtains. The concept of this idea can be applied to any single or multiple light beam emitter and receiver array.

FIG. 1, a light curtain consists mainly of the following parts; 2 columns, a control system which, may or may not be integrated into one of the columns. The first column 10 consists of a single or an array of light emitting element(s) 11, the second column 20 consists of a single or an array of light receiving element(s) 21 which are synchronized together by an optical or non-optical means 22. The control system or central processing unit(s), usually located in the receiving unit 20 or in a separate box, controls which light emitting element turns ON and confirms if the light 12 has been received by the respective light receiving element. If not received, then the outputs of the light curtain turn OFF in order to issue a stop command to the machine of which it is connected. This is the basic idea behind the functionality of most of these types of devices. Because of the many different manufacturers, schemes may vary from curtain to curtain in exactly how they function. One feature of a safety light curtain is that they have to be unaffected by ambient light, if they become affected, then they must automatically shutdown and go into a “lock-out” mode until the problem is remedied and the unit is reset.

There are currently two types of safety light curtains: Type 2 and Type 4 (as per IEC 61496-1) they are used in different categories of safety (Categories B, 1, 2, 3 and 4 as per EN954). The category used depends upon various factors taken into consideration during a risk assessment, EN1050 is an example of a standard which could be used. Some of these factors are; severity of injury, frequency of exposure and possibility of avoidance of the hazard. Once a category has been chosen, the appropriate “type” of products can be applied to the design of the overall safety system.

Beam divergence in type 4 safety light curtains must be no more than +/−2.5 degrees over the rated operating range of the device (as per IEC 61496-2), beam divergence in type 2 safety light curtains is +/−5 degrees.

Beam spacing and reaction time will determine how close the safety light curtain can be mounted to the hazardous part of a machine of which you are trying to guard. For example, if the safety light curtain has a beam spacing of 10 mm, the minimum detectable object size would be approximately 15 mm (roughly equivalent to the diameter of a human finger), therefore, if it can detect a finger going into its' field. This means it can be mounted closer to the hazard than a safety light curtain with a larger beam spacing, which may have a minimum detectable object size of 25 mm or 30 mm which would only be able to detect the thickness of your hand. These “minimum detectable object” sizes have been compiled by numerous studies and are outlined in standards like prEN999.

In some applications a single pair of safety light curtains is used to surround a machine or area through the use of mirrors. Mirrors are used to bounce the light from the emitter array around a corner or multiple corners to its respective detector array. However the mirrors used in these applications are flawed and a de-rating factor must be applied due to losses in the reflective surface, typically this value is around 12%.

Some of the main reasons for not using multiple sets of safety light curtains are cost of the units, mounting, set-up and wiring. When using mirrors, alignment is the main downfall; skew, pitch and tilt of each column and mirror compound misalignment.

### OBJECTS AND SUMMARY OF THE INVENTION

The object of this invention is to provide a means of repeating the light signal within a new or existing light curtain system for the purpose of angling the light around a corner or to extend the effective range of a fixed system.

Herein is described 3 main embodiments of this invention, the first of which is a basic configuration where the repeater system is divided into 2 columns, a receiver and emitter located within close proximity of each other. Each detecting element would be parallel connected to its' respective emitting element in a one to one configuration. The array of detecting and emitting element(s) could have the similar optical and/or electrical characteristics as the light curtain of which it is being used with. For example; beam spacing or pitch, beam divergence, light intensity, receiver sensitivity, etc. . . .

The second embodiment would contain all of the same characteristics as the first with the addition of a received light intensity indicator. The received light, once converted to an electrical signal would be represented audibly and/or displayed visually, i.e. bar graph, numeric display, mechanical meter movement, or any other type of display device. The display would aid in the alignment and positioning of the repeater and light curtain system.

The third embodiment would contain all of the same characteristics as the first and/or second. This embodiment would allow the receiver and emitter columns of the repeater to be separated over greater distances. Each element in the receiver column would be united at a common point; the receiver and emitter column would have a communication link between them. When an element is receiving light, the information is collected by the receiver column and is sent over the communication link to a common point in the emitter column that would then turn on the corresponding light emitting element.

### BRIEF DESCRIPTION OF THE DRAWINGS

FIG. 1 is a typical safety light curtain system consisting of an emitter and receiver where the control system is contained within the receiver column.

FIG. 2 shows a safety light curtain system with the first embodiment of a repeater inserted between the emitter and receiver columns.

FIG. 3 shows a safety light curtain system with the second embodiment of a repeater inserted between the emitter and receiver columns. The repeater contains a received light intensity display.

FIG. 4 shows a safety light curtain system with the third embodiment of a repeater inserted between the emitter and detector columns. The repeater contains a received light intensity display and a method of providing a larger separation between the receiver and emitting columns of the repeater.

### DETAILED DESCRIPTION OF THE INVENTION

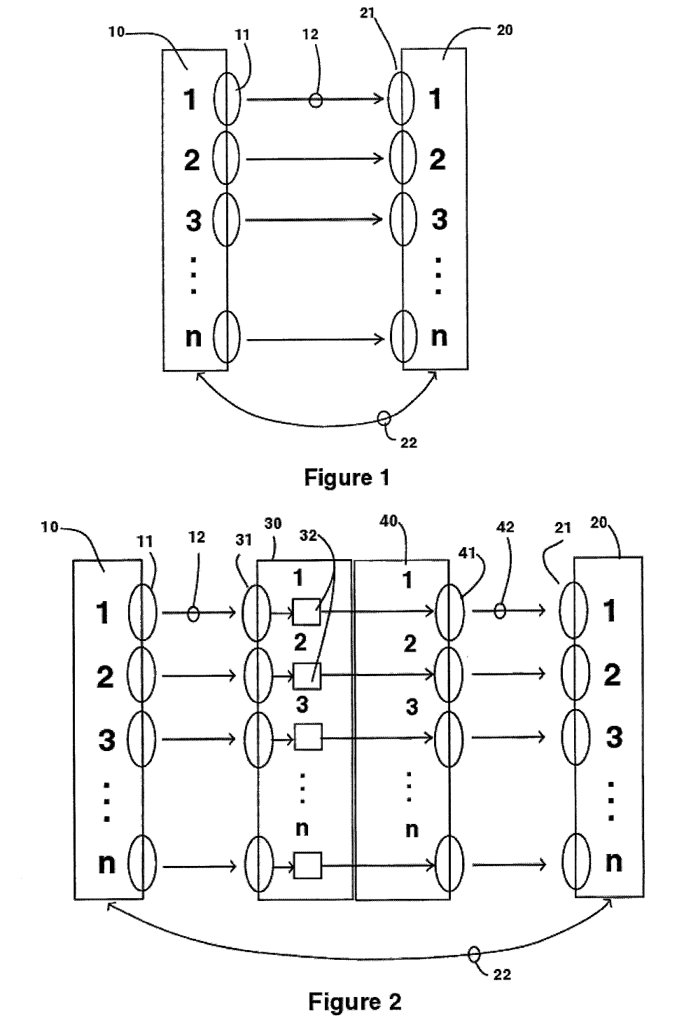

FIG. 1, a light curtain consists of 2 columns and could have a control system which, may or may not be integrated into one of the columns. The first column 10 consists of a single or an array of light emitting element(s) 11, the second column 20 consists of a single or an array of light receiving element(s) 21 which are could be synchronized together by an optical or non-optical means 22. The control system or central processing unit(s), usually located in the receiving unit 20 or in a separate box, controls which light emitting element turns ON and confirms if the light 12 has been received by the respective light receiving element. If not received, then the outputs of the light curtain turn OFF in order to issue a stop command to the machine of which it is connected.

FIG. 2, outlines the underlying concept of the patent, where a repeater(s) is inserted between the emitter 10 and receiver 20 of a light curtain. The light 12 from the emitter 10 of the light curtain is intercepted into a single or an array of detecting element(s) 31 that have similar characteristics as the receiving element(s) 21 which are located in the receiver column 20 of the safety light curtain. The light 12 received by the repeater receiver 30 is transformed into an electrical signal which is then compared to a reference value by the electronic circuit 32. If the electrical signal is above a predetermined threshold then the electronic circuit 32 turns on the corresponding emitting element 41 in the emitter column 40 of the repeater. The emitter element 41 sends light 42 to the receiving array 20 of the safety light curtain pair.

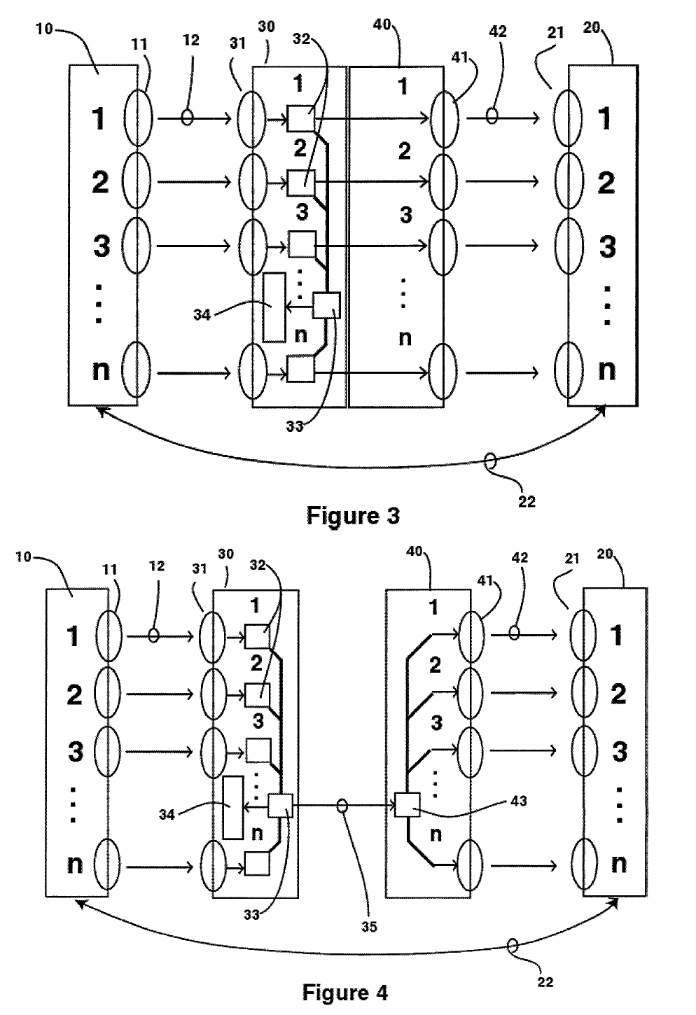

FIG. 3, illustrates the addition of a received light intensity indicator 34 to the repeater. The electronic circuit 33 collects and processes the electrical information from the electronic circuit(s) 32, the information is then presented on the received light intensity indicator 34.

The electronic circuit 32 in FIG. 2 did a comparison of the received light intensity information versus a reference value. In addition to this function, the circuit provides an electrical value of the level of received light. The electronic circuit 33 would then mathematically compile the information and present it in an audible or visual form through the indicator 34.

FIG. 4, in addition to the aforementioned provisions of the light repeating device and received light intensity indicator is a scheme to extend the physical separation of the receiving and emitting arrays. The information collected by the electronic circuit 33 is connected by a communications link to the emitting array 40. The communication link 35 terminates at electronic circuit 43, which then activates the corresponding emitting element 41 contained in emitter column 40.

One other possible consideration would involve the synchronization of the repeater with the light curtain. Simple light curtain systems do not have emitter and receiver synchronization and therefore this would not apply. However, in light curtain systems with a communication link between them the repeater could be connected to the link in order to provide it with timing and/or enabling with respect to when a receiving and/or emitting element turns on and off. Another possibility would include the light curtain system to control the repeater as an integral part of its' system, instead of the repeater being connected to the communications links as a listening device, it would interface the to the system in order to send and receive information.

What is claimed:

1. All embodiments of this invention will consist of:
1.1. At least a single light-receiving element, or an array of elements, which will intercept the light emitted by a light curtain. The invention may contain an electrical circuit to convert the received light into an electrical signal and may amplify or re-shape the electrical signal for the purposes of re-transmission.
1.2. At least a single light-emitting element or an array of elements that re-transmit the electrical signal, from the electrical circuit(s) connected to the light-receiving element(s), in the form of a light transmission to the receiver of the light curtain.

2. The frequency and wavelength of the light received and transmitted by the repeater will be dependent upon the light curtain used.

3. In addition to the claims above, the light receiving and emitting element(s) may be contained in the same enclosure or be located within different enclosures linked either by a electrical or non-electrical means, i.e. twisted pair wire, fibre optic cable, radio transmission, etc.

4. The repeater system could be synchronized by an electrical or non-electrical means to the light curtain system.

5. The repeater system could be controlled by the light curtain system.

6. In addition to the claims above, said device has the option to incorporate a “received light indicator”, this indicator could be audible or visible and could do any of the following:
6.1. Indicate sufficient light reception on the receiving element(s)
6.2. Indicate the sum of light detected by the receiving element(s)
6.3. Indicate an average of the light detected by the receiving element(s)
6.4. Or, indicate any other type of mathematical computation that relates to the amount of received light.

7. The received light indicator could be visual or audible;
7.1. The visual display could be any type of device that would portray a bar graph, numeric value, or representative value of the status of the received light.
7.2. The visual display could also be a mechanical meter movement.
7.3. An audible device could be any sound emitting device that would represent the status or received light of the repeater, by single, multiple or by an array of tones.

8. The received light intensity indicator would act independently of each light receiving and emitting element(s).

9. The received light indicator could be located in either the light receiver column or the light-emitting column of the repeater or both.
One embodiment could contain a visible means of indication that each of the light receiving element(s) of the repeater has received light. This would include, but is not limited to light emitting diodes (LED) in the visible spectrum of light located beside each receiving element in the receiver column or beside each light emitting element in the emitter column or both.
